(19) United States
(12) Patent Application Publication
(10) Pub. No.: US 2026/0319211 A1
(43) Pub. Date: Oct. 15, 2026

(54) CABLE, INFORMATION MANAGEMENT SYSTEM FOR CABLE, AND INFORMATION MANAGEMENT METHOD FOR CABLE

(71) Applicant: SUMITOMO ELECTRIC INDUSTRIES, LTD., Osaka (JP)

(72) Inventors: Fumiaki SATO, Osaka (JP); Maki INAI, Osaka (JP)

(21) Appl. No.: 19/117,105

(22) PCT Filed: Dec. 19, 2022
(86) PCT No.: PCT/JP2022/046704

§ 371 Date: Mar. 31, 2025

(51) Int. Cl. G02B 6/44

(52) U.S. Cl. CPC G02B 6/4482

(57) ABSTRACT

The application discloses a cable. The cable includes a cable core and a sheath formed around the cable core, in which a two-dimensional code is attached to the cable core. As another aspect, the application discloses an information management system for the cable. The information management system includes: a reading unit configured to read cable information stored in the two-dimensional code; and a display unit configured to display the cable information.

### TECHNICAL FIELD

The present disclosure relates to a cable, an information management system for the cable, and an information management method for the cable.

### BACKGROUND ART

In the related art, a technique for checking information related to a cable, such as information related to installation of the cable, has been developed. For example, Patent Literature 1 discloses a method of providing, on or near an installed optical cable, a recording unit that encodes and records information related to installation of the optical cable, and recording and reading out the information related to the installation of the optical cable at a site where the optical cable is installed.

### CITATION LIST

### Patent Literature

Patent Literature 1: JP2001-021730A

### SUMMARY OF INVENTION

A cable according to an aspect of the present disclosure is a cable including: a cable core; and a sheath formed around the cable core, in which a two-dimensional code is attached to the cable core.

An information management system for a cable according to an aspect of the present disclosure is an information management system for a cable, the cable including a cable core and a sheath formed around the cable core, a two-dimensional code being attached to the cable core, the information management system including: a reading unit configured to read cable information stored in the two-dimensional code; and a display unit configured to display the cable information.

An information management method for a cable according to an aspect of the present disclosure is an information management method for a cable, the cable including a cable core and a sheath formed around the cable core, a two-dimensional code being attached to the cable core, the information management method including: a step of reading cable information stored in the two-dimensional code; and a step of displaying the cable information.

### BRIEF DESCRIPTION OF DRAWINGS

FIG. 1 is a diagram illustrating an example of a configuration of a cable according to an embodiment of the present disclosure.

FIG. 2 is a diagram illustrating details of a cable core illustrated in FIG. 1.

FIG. 3 is a diagram illustrating an example of an information management system that reads and displays cable information stored in two-dimensional codes illustrated in FIG. 2.

FIG. 4 is a flowchart illustrating an example of a flow of an operation of reading the cable information stored in the two-dimensional codes illustrated in FIG. 2.

FIG. 5 is a diagram illustrating an example of cable information displayed on a glass surface of an AR glass illustrated in FIG. 3.

FIG. 6 is a diagram illustrating a configuration of a cable according to Modification 1 of the embodiment of the present disclosure.

FIG. 7 is a diagram illustrating a configuration of a cable according to Modification 2 of the embodiment of the present disclosure.

### DESCRIPTION OF EMBODIMENTS

### Technical Problem

As in the method described in Patent Literature 1, when a printed paper for a two-dimensional code or the like is attached to a sheath of a cable, the printed paper may be rubbed or peeled off at the time of installation or the like of the cable.

An object of the present disclosure is to provide a cable in which information related to the cable can be easily checked and identifiability of the information can be ensured, an information management system for the cable, and an information management method for the cable.

### Advantageous Effects of Present Disclosure

According to the present disclosure, the information related to the cable can be easily checked, and the identifiability of the information can be ensured.

### Description of Embodiment of Present Disclosure

First, aspects of the present disclosure will be listed and described.

A cable according to an aspect of the present disclosure is
(1) a cable including: a cable core; and a sheath formed around the cable core, in which a two-dimensional code is attached to the cable core.

In this way, with a configuration in which the two-dimensional code is attached to the cable core provided inside the sheath, not to the outside of the sheath, it is possible to prevent the two-dimensional code from disappearing due to friction or the like at the time of installation of the cable, and it is possible to ensure the identifiability of the information related to the cable, and the like. In addition, the information related to the cable can be easily checked. In addition, since the two-dimensional code cannot be seen from the outside when the sheath is provided, it is particularly effective when information is stored that is not desired to be actively displayed for a third party. Further, for example, it is possible to present a large amount of information by storing, in the two-dimensional code, a URL of a WEB page in which the information related to the cable is described, or the like.
(2) In the cable according to the above-described (1), the cable core may include an optical fiber.

The cable is an optical fiber cable, and various kinds of information such as a manufacturer, a product type, and a length is required for the optical fiber cable at the time of installation of the optical fiber cable, and therefore, a configuration in which the two-dimensional code is attached to the cable core as described above is particularly effective.
(3) In the cable according to the above-described (2), the cable core may include a plurality of optical fibers and an overwrapping tape wrapped around the plurality of optical fibers, and the two-dimensional code may be attached to the overwrapping tape.

With such a configuration, it is possible to check information stored in the two-dimensional code in a state in which the sheath is removed.
(4) In the cable according to the above-described (2), the cable core may include a plurality of optical fibers and a slot rod in which the plurality of optical fibers are housed, and the two-dimensional code may be attached to the slot rod.

With such a configuration, for example, it is possible to select the optical fiber to be worked out from the plurality of optical fibers by checking information stored in the two-dimensional code attached to the slot rod exposed after the sheath is removed.
(5) In the cable according to the above-described (2), the cable core may include a plurality of optical fibers and a plurality of tubes configured to respectively cover a plurality of subunits in which the plurality of optical fibers are bundled, and the two-dimensional code may be attached to one or more of the plurality of tubes.

With such a configuration, for example, it is possible to select the subunit including the optical fiber to be worked out from the plurality of subunits by checking information stored in the two-dimensional code attached to the tube exposed after the sheath is removed.
(6) In the cable according to any one of the above-described (1) to (5), the two-dimensional code may store information related to installation of the cable.

With such a configuration, it is possible to provide useful information to a worker at the time of installation of the cable.

An information management system for a cable according to an aspect of the present disclosure is
(7) an information management system for a cable, the cable including a cable core and a sheath formed around the cable core, a two-dimensional code being attached to the cable core, the information management system including: a reading unit configured to read cable information stored in the two-dimensional code; and a display unit configured to display the cable information.

In this way, with the configuration in which the two-dimensional code is attached to the cable core provided inside the sheath, not to the outside of the sheath, it is possible to prevent the two-dimensional code from disappearing due to friction or the like at the time of installation of the cable, and it is possible to ensure the identifiability of the cable information. In addition, since the two-dimensional code cannot be seen from the outside when the sheath is provided, it is particularly effective when cable information is stored that is not desired to be actively displayed for a third party. Further, for example, it is possible to present a large amount of information by storing, in the two-dimensional code, a URL of a WEB page in which the information related to the cable is described, or the like. Further, with a configuration of displaying the cable information, the cable information can be easily checked.

An information management method for a cable according to an aspect of the present disclosure is
(8) an information management method for a cable, the cable including a cable core and a sheath formed around the cable core, a two-dimensional code being attached to the cable core, the information management method including: a step of reading cable information stored in the two-dimensional code; and a step of displaying the cable information.

In this way, with the configuration in which the two-dimensional code is attached to the cable core provided inside the sheath, not to the outside of the sheath, it is possible to prevent the two-dimensional code from disappearing due to friction or the like at the time of installation of the cable, and it is possible to ensure the identifiability of the cable information. In addition, since the two-dimensional code cannot be seen from the outside when the sheath is provided, it is particularly effective when cable information is stored that is not desired to be actively displayed for a third party. Further, for example, it is possible to present a large amount of information by storing, in the two-dimensional code, a URL of a WEB page in which the information related to the cable is described, or the like. Further, with the configuration of displaying the cable information, the cable information can be easily checked.

### Details of Embodiment of Present Disclosure

A specific example of a cable according to an embodiment of the present disclosure will be described below with reference to the drawings. It should be noted that the present disclosure is not limited to these examples, but is indicated by claims, and is intended to include all changes within the meaning and scope equivalent to the claims.

### Configuration of Cable

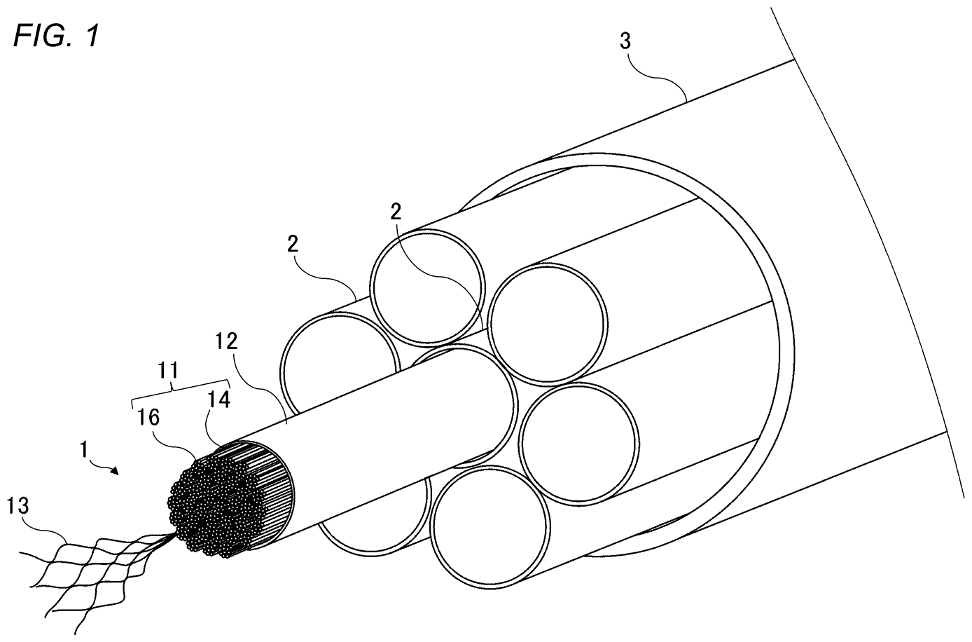

FIG. 1 is a diagram illustrating an example of a configuration of a cable 1 according to an embodiment of the present disclosure. FIG. 1 illustrates a state in which each cable 1 is installed inside a subduct 2 and a plurality of subducts 2 are installed inside a main duct 3. The cable 1 is, for example, a micro duct cable that is installed inside the subduct 2 by air pumping or pulling, and has an outer diameter of about 20 mm. In the cable 1 having a small radius of curvature, it is difficult to read a two-dimensional code 15 described later, and thus the outer diameter of the cable 1 is preferably 6 mm or more.

The cable 1 is, for example, an optical fiber cable, and includes a cable core 11 and a sheath 12 formed around the cable core 11. The cable core 11 includes a plurality of optical fiber ribbons 16 each including optical fibers 13 and an overwrapping tape 14 that covers a periphery of the plurality of optical fiber ribbons 16. For example, regarding the optical fibers 13 constituting the optical fiber ribbon 16, adjacent optical fibers 13 may be intermittently coupled to each other along a longitudinal direction of the cable 1. The plurality of optical fibers 13 are coupled to each other to form an optical fiber ribbon, but may be separate.

The overwrapping tape 14 is longitudinally wrapped or helically wrapped around the plurality of optical fiber ribbons 16. In addition, the overwrapping tape 14 is made of a material such as polyethylene or polyester, and has a smooth surface. The overwrapping tape 14 has an arithmetic mean roughness Ra of, for example, 10 μm or less.

The cable 1 illustrated in FIG. 1 is a slot-less type, but may be a slot type. In the slot-less type cable 1 illustrated in FIG. 1, the sheath 12 is made of a resin such as high-density polyethylene (HDPE), and is formed, for example, by extrusion molding around the overwrapping tape 14.

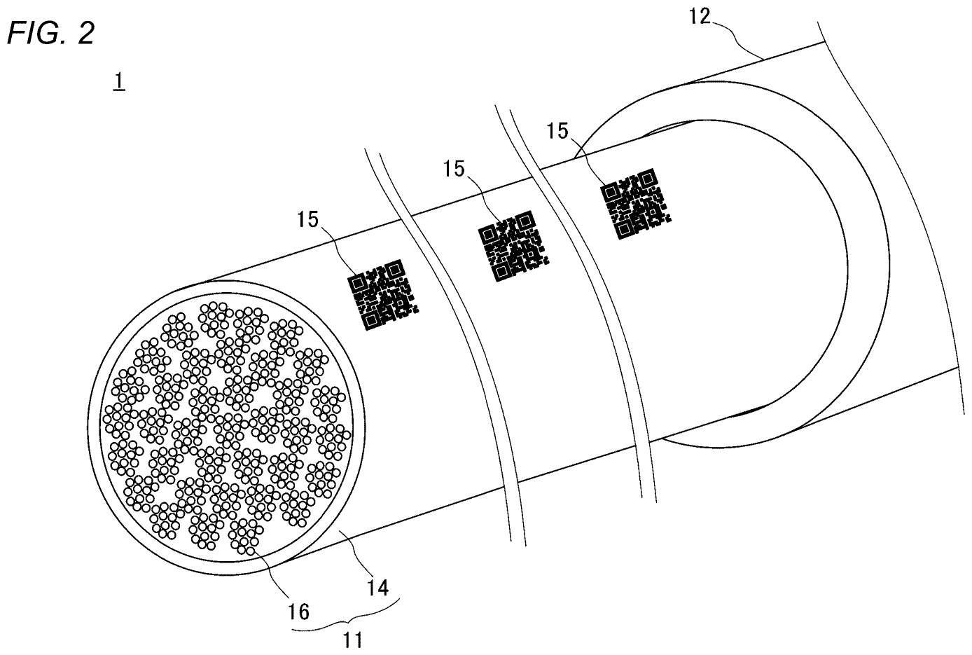

FIG. 2 is a diagram illustrating details of the cable core 11 illustrated in FIG. 1. FIG. 2 illustrates a state in which a part of the sheath 12 illustrated in FIG. 1 is removed. Referring to FIG. 2, two-dimensional codes 15 in which information related to the cable 1 (hereinafter referred to as “cable information”) is stored are attached to the cable core 11. In an example illustrated in FIG. 2, QR codes (registered trademark) that can record a large amount of information such as characters and numbers and enable high-speed reading are attached to the overwrapping tape 14 as the two-dimensional codes 15.

The two-dimensional code 15 may be printed by an ink jet printer or the like, or may be laser-engraved. In addition, a paper, an IC chip, or the like on which the two-dimensional code 15 is printed may be attached to the overwrapping tape 14. As described above, since the surface of the overwrapping tape 14 is formed to be smooth, a work of attaching the two-dimensional codes 15 can be easily performed.

It is preferable that the two-dimensional code 15 has a color different from a color of the overwrapping tape 14. Accordingly, a position to which the two-dimensional code 15 is attached can be easily checked. The cable information includes, for example, information related to installation of the cable 1, specifically, at least one piece of following information: manufacturing company, manufacturing year, management number, the number of optical fibers, allowable tension, allowable bending diameter, and use temperature.

As described above, the two-dimensional code 15 is attached to the overwrapping tape 14 provided inside the sheath 12, so that it is possible to prevent the two-dimensional code 15 from disappearing due to friction or the like at the time of installation of the cable 1, and it is possible to ensure the identifiability of the cable information. In addition, since the two-dimensional code 15 cannot be seen from the outside when the sheath 12 is provided, cable information that is not desired to be actively displayed for a third party can be stored.

Further, for example, two-dimensional codes 15 are attached to the overwrapping tape 14 at a plurality of positions at predetermined intervals along a longitudinal direction of the cable 1. The predetermined interval is in a range of 30 cm to 1 m, for example. For example, in each of the two-dimensional codes 15, the same cable information may be stored, or cable information having a content corresponding to a position to which the two-dimensional code 15 is attached may be stored.

### Information Management System of Cable Information

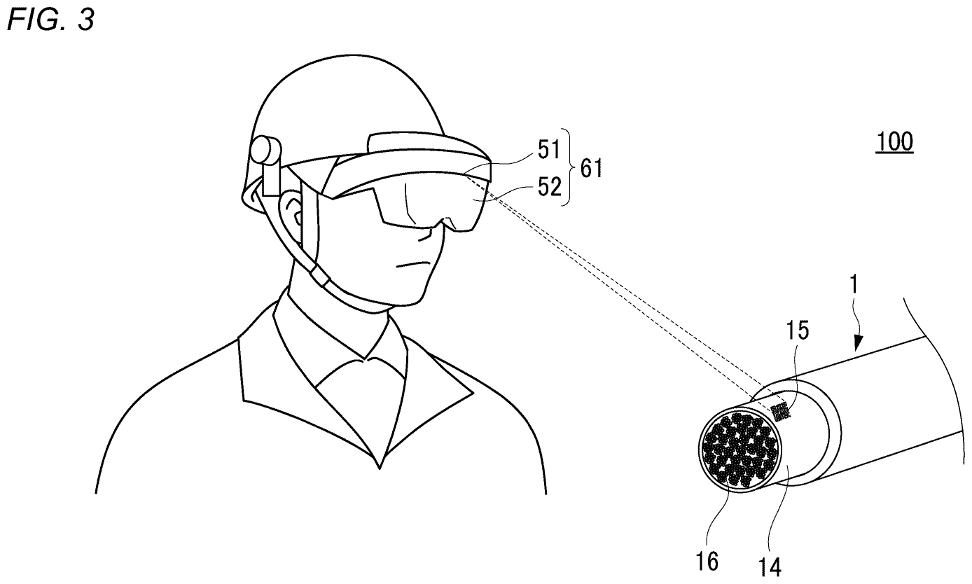

FIG. 3 is a diagram illustrating an example of an information management system 100 that reads and displays the cable information stored in the two-dimensional codes 15 illustrated in FIG. 2. Referring to FIG. 3, the information management system 100 includes a reading unit 51 that reads the cable information and a display unit 52 that displays the cable information read by the reading unit 51 on a screen or the like. In an example illustrated in FIG. 3, an argumented reality (AR) glass 61 including both the reading unit 51 and the display unit 52 reads and displays the cable information. The display unit 52 in the AR glass 61 displays the cable information on a glass surface of the AR glass 61.

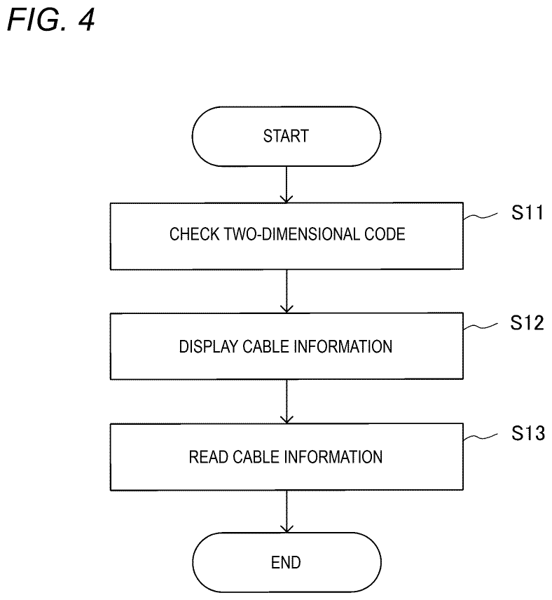

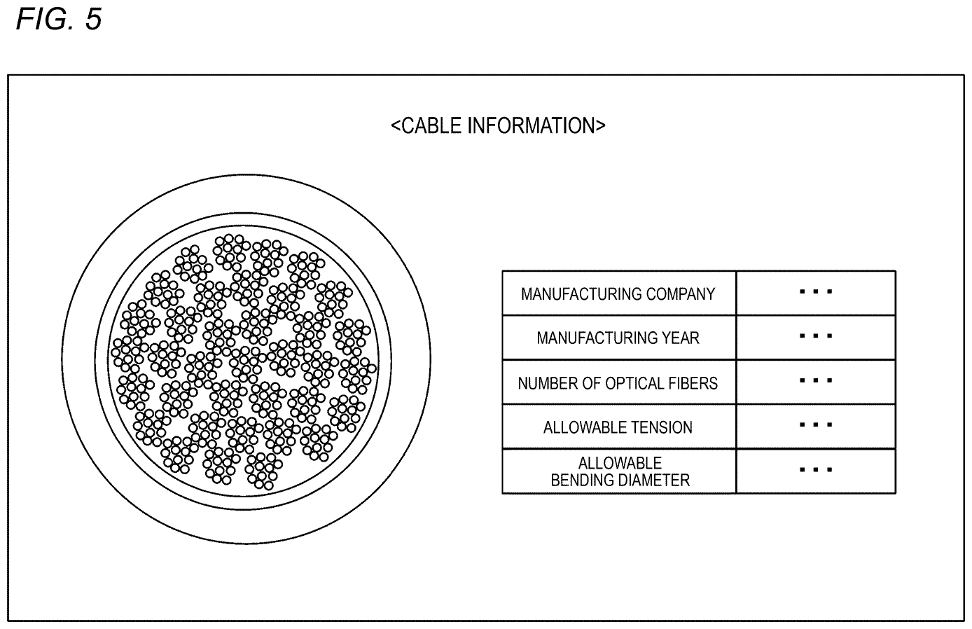

FIG. 4 is a flowchart illustrating an example of a flow of an operation of reading the cable information stored in the two-dimensional codes 15 illustrated in FIG. 2. FIG. 5 is a diagram illustrating an example of the cable information displayed on the glass surface of the AR glass 61 illustrated in FIG. 3.

With reference to FIGS. 3 to 5, first, before or during an installation work, a worker who performs the installation of the cable 1 removes a part of the sheath 12 of the cable 1 and checks one of the plurality of two-dimensional codes 15 in a state in which the AR glass 61 is mounted on a head (step S11). For example, the worker removes the sheath 12 by about 2 m along the longitudinal direction of the cable 1. Accordingly, at least one two-dimensional code 15 can be exposed.

Next, the worker views the two-dimensional code 15 using the AR glass 61. At this time, as the head of the worker moves, the reading unit 51 is directed toward the two-dimensional code 15. Accordingly, the reading unit 51 in the AR glass 61 reads the cable information stored in the two-dimensional code 15 (step S12).

Next, the display unit 52 in the AR glass 61 displays the cable information read by the reading unit 51 on the glass surface of the AR glass 61 (step S13). For example, as illustrated in FIG. 5, a list of the manufacturing company, the manufacturing year, the number of optical fibers, the allowable tension, and the allowable bending diameter of the cable 1 is displayed on the glass surface of the AR glass 61.

As described above, the cable information is displayed on the glass surface of the AR glass 61, so that the worker can easily check the cable information useful for the installation work without looking at a specification or an instruction manual of the cable 1 before or during the installation work. In addition, since the worker can check the cable information displayed on the AR glass 61 and perform the installation work of the cable 1 in parallel, the workability can be further improved.

The reading unit 51 and the display unit 52 are not limited to being provided in the AR glass 61, and may be provided in other devices such as a smartphone. In addition, the reading unit 51 and the display unit 52 may be provided in separate devices.

The two-dimensional code 15 other than the QR code, such as a data matrix, may be attached to the overwrapping tape 14. In addition, the two-dimensional code 15 may store a uniform resource locator (URL) of a web page in which the cable information is described, or the like. In this case, for example, after reading the URL of the WEB page, the AR glass 61 can display, based on the URL, the WEB page in which the cable information is described on the glass surface. Accordingly, a large amount of information related to the cable 1 can be presented to the worker. When the cable 1 is the optical fiber cable, various kinds of information such as a manufacturer, a product type, and a length is required at the time of installation. Therefore, as described above, a configuration in which a large amount of information can be presented is particularly effective.

The two-dimensional code 15 may store identification information of the cable 1 (hereinafter referred to as “cable ID”), an Internet Protocol (IP) address of an external server that manages the cable information, and the like.

In this case, the information management system 100 includes the external server. For example, the AR glass 61 can read the cable ID and the IP address stored in the two-dimensional code 15 and request, based on the cable ID and the IP address, the cable information of the cable 1 from the external server via the network. When the cable ID transmitted from the AR glass 61 is received, the external server can transmit the cable information corresponding to the cable ID to the AR glass 61, and the AR glass 61 can display the cable information transmitted from the external server on the glass surface.

When the device such as the AR glass or the smartphone includes the reading unit 51 and the display unit 52, the worker can acquire information related to cable pumping having a more detailed content such as an expected pumping distance or attention information during pumping by inputting into the device various types of information such as a model of a pumping device, a pumping route, a diameter of the subduct 2, a radius of curvature of the subduct 2, and an outside air temperature.

Specifically, when the reading unit 51 in the device reads the cable ID and the IP address stored in the two-dimensional code 15, the device transmits, based on the IP address, the above-described various kinds of information input by the worker and the cable ID to the external server.

The external server stores, for example, a database in which various kinds of information related to the installation, the cable ID, the expected pumping distance, an attention point during the pumping, a result of a past pumping test, and the like are associated. When the various kinds of information and the cable ID transmitted from the device are received, the external server can read, based on the various kinds of information and the cable ID, the expected pumping distance and the attention point during the pumping, and transmit the read content to the device. Accordingly, more detailed information related to cable pumping can be presented to the worker.

To access the database in the external server, a dedicated portal site may be utilized, and a system in which only an authorized person can log in may be adopted.

In FIGS. 1 and 2, the optical fiber cable is illustrated as an example of the cable 1, but the cable 1 is not limited to the optical fiber cable, and may be another type of cable such as a cable including a metal electronic wire.

### Modification 1 of Position to Which Two-Dimensional Code is Attached

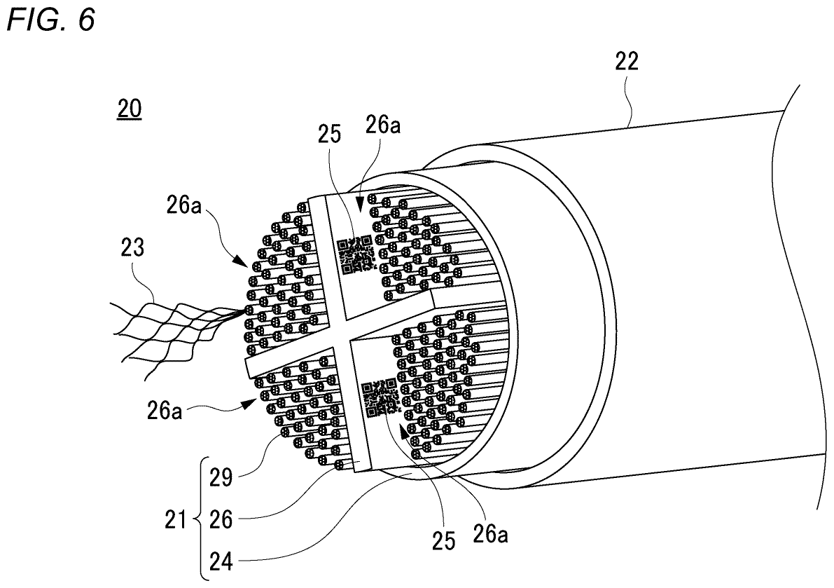

FIG. 6 is a diagram illustrating a configuration of a cable 20 according to Modification 1 of the embodiment of the present disclosure. Referring to FIG. 6, the cable 20 includes a cable core 21 and a sheath 22. The cable core 21 includes a plurality of optical fiber ribbons 29 each including optical fibers 23, an overwrapping tape 24, and a slot rod 26 in which the plurality of optical fiber ribbons 29 are housed. The sheath 22, the optical fiber ribbon 29, and the overwrapping tape 24 have the same configurations as the sheath 12, the optical fiber ribbon 16, and the overwrapping tape 14 illustrated in FIG. 2, respectively.

The slot rod 26 is made of, for example, a material such as polyethylene or polyester. In addition, the slot rod 26 has a plurality of slot grooves 26a, and a plurality of optical fiber ribbons 29 are housed in each slot groove 26a. In an example illustrated in FIG. 6, four slot grooves 26a are formed.

Two-dimensional codes 25 are attached to the slot rod 26. Specifically, the two-dimensional code 25 is attached to an inner wall forming each of the plurality of slot grooves 26a of slot rod 26. In the example illustrated in FIG. 6, the two-dimensional code 25 is attached to the inner wall of each slot groove 26a. Accordingly, for example, the worker can check cable information stored in the two-dimensional codes 25.

The two-dimensional code 25 may be attached to the inner wall of any one of the plurality of slot grooves 26a. Further, in each of the plurality of two-dimensional codes 25, the same cable information may be stored, or cable information having a content corresponding to the slot groove 26a to which the two-dimensional code 25 is attached may be stored.

Further, in the cable 20, in addition to the two-dimensional codes 25 attached to the slot rod 26, a two-dimensional code may be attached to the overwrapping tape 24 as in the cable 1 illustrated in FIG. 2.

### Modification 2 of Position to Which Two-Dimensional Code is Attached

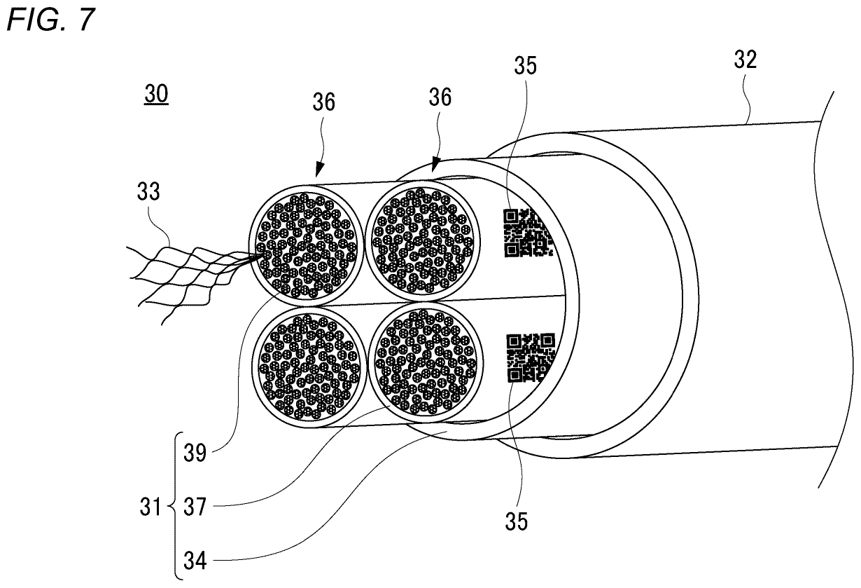

FIG. 7 is a diagram illustrating a configuration of a cable 30 according to Modification 2 of the embodiment of the present disclosure. Referring to FIG. 7, the cable 30 includes a cable core 31 and a sheath 32. The cable core 31 includes a plurality of optical fiber ribbons 39 each including optical fibers 33, an overwrapping tape 34, and a plurality of tubes 37. The sheath 32, the optical fiber ribbon 39, and the overwrapping tape 34 have the same configurations as the sheath 12, the optical fiber ribbon 16, and the overwrapping tape 14 illustrated in FIG. 2, respectively.

The plurality of optical fiber ribbons 39 are divided into a plurality of subunits 36. In an example illustrated in FIG. 7, the plurality of optical fiber ribbons 39 are divided into four subunits 36. A plurality of optical fiber ribbons 39 in each subunit 36 are covered by the tube 37 in a bundled state.

The tube 37 is made of, for example, a material such as polyethylene or polyester. A two-dimensional code 35 is attached to an outer side of the tube 37. In the example illustrated in FIG. 7, the two-dimensional code 35 is attached to each tube 37. Accordingly, for example, the worker can easily select the subunit 36 to be worked out from the plurality of subunits 36 by checking cable information stored in the two-dimensional codes 35.

The two-dimensional code 35 may be attached to any one of the plurality of tubes 37. Further, in each of the plurality of two-dimensional codes 35, the same cable information may be stored, or cable information having a content corresponding to the tube 37 to which the two-dimensional code 35 is attached may be stored.

In the cable 30, in addition to the two-dimensional codes 35 attached to the tubes 37, a two-dimensional code may be attached to the overwrapping tape 34 as in the cable 1 illustrated in FIG. 2.

The present disclosure has been described above based on the specific embodiment. However, the present invention is not limited to these exemplifications, but is indicated by the scope of claims, and is intended to include all modifications within a scope and meaning equivalent to the scope of claims.

### REFERENCE SIGNS LIST

1, 20, 30: cable
2: subduct
3: main duct
11, 21, 31: cable core
12, 22, 23: sheath
13, 23, 33: optical fiber
14, 24, 34: overwrapping tape
15, 25, 35: two-dimensional code
16, 29, 39: optical fiber ribbon
26: slot rod
26a: slot groove
36: subunit
37: tube
51: reading unit
52: display unit
61: AR glass
100: information management system

What is claimed is:

1. A cable comprising:
a cable core; and
a sheath formed around the cable core,
wherein a two-dimensional code is attached to the cable core.

2. The cable according to claim 1,
wherein the cable core comprises an optical fiber.

3. The cable according to claim 2,
wherein the cable core comprises a plurality of optical fibers and an overwrapping tape wrapped around the plurality of optical fibers, and
wherein the two-dimensional code is attached to the overwrapping tape.

4. The cable according to claim 2,
wherein the cable core comprises a plurality of optical fibers and a slot rod in which the plurality of optical fibers are housed, and
wherein the two-dimensional code is attached to the slot rod.

5. The cable according to claim 2,
wherein the cable core comprises a plurality of optical fibers and a plurality of tubes configured to respectively cover a plurality of subunits in which the plurality of optical fibers are bundled, and
wherein the two-dimensional code is attached to one or more of the plurality of tubes.

6. The cable according to claim 1,
wherein the two-dimensional code stores information related to installation of the cable.

7. An information management system for a cable, the cable comprising a cable core and a sheath formed around the cable core, a two-dimensional code being attached to the cable core, the information management system comprising:
a reading unit configured to read cable information stored in the two-dimensional code; and
a display unit configured to display the cable information.

8. An information management method for a cable, the cable comprising a cable core and a sheath formed around the cable core, a two-dimensional code being attached to the cable core, the information management method comprising:
reading cable information stored in the two-dimensional code; and
displaying the cable information.
